(19) United States
(12) Patent Application Publication
(10) Pub. No.: US 2025/0372813 A1
(43) Pub. Date: Dec. 4, 2025

(54) AUTOMATIC SPLICING EQUIPMENT FOR SECONDARY BATTERY AND METHOD

(71) Applicant: HANA TECHNOLOGY CO., LTD., Yongin-si (KR)

(72) Inventors: Jeong Seok JEONG, Suwon-si (KR); Eun Mi LEE, Hwaseong-si (KR)

(21) Appl. No.: 19/222,461

(22) Filed: May 29, 2025

(30) Foreign Application Priority Data
May 31, 2024 (KR) 10-2024-0071252

(51) Int. Cl. H01M 50/406; B65H 19/18; H01M 10/04

(52) U.S. Cl. CPC H01M 50/406; B65H 19/1826; H01M 10/0404

(57) ABSTRACT

Proposed are automatic splicing equipment for a secondary battery and a method thereof and, more specifically, automatic splicing equipment for a secondary battery and a method thereof for improving process efficiency by preventing interruption in film supply during the manufacturing process by connecting a standby spare second film to a film being supplied when the film being supplied is exhausted while supplying the film for a back-end process.

### CROSS REFERENCE TO RELATED APPLICATION

The present application claims priority to Korean Patent Application No. 10-2024-0071252, filed on May 31, 2024, the entire contents of which are incorporated herein for all purposes by this reference.

### BACKGROUND

### Technical Field

The present disclosure relates to automatic splicing equipment for a secondary battery and a method thereof and, more particularly, to automatic splicing equipment for a secondary battery and a method thereof for improving process efficiency by preventing interruption in film supply during the manufacturing process by connecting a standby spare second film to a film being supplied when the film being supplied is exhausted while supplying the film for a back-end process.

### Description of the Related Art

Recently, with the development of electric vehicles, energy storage batteries, robots, satellites, and the like, research on secondary batteries, which are high-performance batteries capable of repetitive charging and discharging, is being actively conducted. Such a secondary battery is typically manufactured by winding the anode and cathode films with a separator interposed therebetween, and a separator is disposed between the two electrode films in order to prevent a short circuit between the two electrode films. The separator for a secondary battery is wound in a roll and input into the secondary battery manufacturing process. When the separator wound on the roll is all exhausted, it must be replaced with a new separator roll before resuming the manufacturing process.

In addition, currently commercialized secondary batteries include nickel cadmium batteries, nickel hydrogen batteries, nickel zinc batteries, lithium secondary batteries, and the like, among which lithium secondary batteries are attracting attention for the advantages of being free to charge and discharge, and having a very low self-discharge rate and high energy density, with almost no memory effect compared to nickel-based secondary batteries.

These lithium secondary batteries mainly utilize lithium-based oxides and carbon materials as the anode active material and cathode active material, respectively. A lithium secondary battery includes an electrode assembly, where a separator is disposed between an anode plate and a cathode plate which are respectively coated with the anode active material and with the cathode active material, and a pouch, an outer material that seals and stores the electrode assembly together with an electrolyte.

In the process of manufacturing such a secondary battery, there are performed a process of forming a shape like a punch model by pressing the pouch on the side where the electrode assembly is to be inserted, a process of cutting the pouch to correspond to individual secondary battery cells, and a process of bending to form the outer shape of the secondary battery by folding the pouch cut in a cell unit in approximately half. Therefore, the pouch should be continuously supplied to the equipment for a back-end process.

In general, the pouch is supplied through a reel-type unwinder, and when the pouch wound around the unwinder is exhausted, the operator should manually replace the unwinder with a new unwinder. As a result, the entire process must be halted to replace the unwinder, which reduces overall manufacturing efficiency. The same issue arises in the separator supply process.

To address the above problems, the present disclosure provides novel automatic splicing equipment and a method for a secondary battery with an improved structure, as will be described in detail below.

### RELATED ART DOCUMENTS

### Patent Document

(Patent Document 1) Korean Patent No. 10-2370747, “Splicing Device of Secondary Battery Separator and Method the Same”

### SUMMARY

As contrived in order to solve the problems of the prior art mentioned above, an objective of the present disclosure is to provide automatic splicing equipment for a secondary battery and a method thereof, which improve process efficiency by preventing the supply of a film from being interrupted while performing the process by connecting or joining a standby spare second film to the film being supplied when the film is exhausted while supplying a first film for a back-end process.

In addition, an objective of the present disclosure is to provide automatic splicing equipment for a secondary battery and a method thereof, which enable automatically determining the remaining amount of a first film wound around a first unwinder by placing a detector on a side adjacent to the first unwinder.

In addition, an objective of the present disclosure is to provide automatic splicing equipment for a secondary battery and a method thereof, which facilitate structural simplification and accordingly design convenience by configuring to enable a gripper for picking an end side of a second film to move only through a straight path rather than a rotation path.

In addition, an objective of the present disclosure is to provide automatic splicing equipment for a secondary battery and a method thereof, which facilitate easy accessibility by allowing a gripper to move to an original position accessible to an operator when supplying a second film in the gripper.

In addition, an objective of the present disclosure is to provide automatic splicing equipment for a secondary battery and a method thereof, which prevent lowering process efficiency due to no need to stop an operation of the equipment by allowing a gripper to move to an original position outside the equipment when supplying a second film in the gripper.

In addition, an objective of the present disclosure is to provide automatic splicing equipment for a secondary battery and a method thereof, which allow a second film to be easily recovered to an outside of the equipment without separate recovery equipment by allowing a gripper fixed on one side of the second film to move from a cutting standby position to an original position after cutting the second film.

In addition, an objective of the present disclosure is to provide automatic splicing equipment for a secondary battery and a method thereof, which prevent damage to a first film being supplied in advance when a gripper moves from an original position to a cutting standby position by forming a damage prevention unit inside the gripper.

In addition, an objective of the present disclosure is to provide automatic splicing equipment for a secondary battery and a method thereof, which prevent the possibility of safety accidents in advance by preventing an end side of a cutter from being exposed to an outside of a first adsorption unit under normal circumstances.

In addition, an objective of the present disclosure is to provide automatic splicing equipment for a secondary battery and a method thereof, which increase the density of the equipment and prevent the entire equipment from becoming unnecessarily large by allowing a mounting unit, where a tape is mounted, to access a film through an isolated space between a pair of units of a second adsorption unit.

The present disclosure may be implemented by exemplary embodiments having the following configurations in order to achieve the objectives described above.

According to an exemplary embodiment of the present disclosure, automatic splicing equipment for a secondary battery according to the present disclosure includes an unwinder comprising a first unwinder for supplying a first film by rotating in one direction while the first film is wound in a roll; and a second unwinder for supplying a second film by rotating in one direction while the second film is wound in a roll; a gripper for moving in a straight line while one side of the second film is fixed; a vacuum adsorption unit comprising a first adsorption unit and a second adsorption unit that are spaced apart from each other and configured to respectively vacuum-adsorb the facing surfaces of the first film and the second film; a cutter disposed in an isolated space between a pair of units of the first adsorption unit, the cutter being configured to move an end portion in a straight line toward or away from the second adsorption unit; a tape supplier disposed adjacent to the second adsorption unit and configured to move linearly toward or away from the first adsorption unit; and a controller configured to control operations of the automatic splicing equipment for the secondary battery.

According to another exemplary embodiment of the present disclosure, the unwinder of the automatic splicing equipment for the secondary battery according to the present disclosure may further include a detector disposed adjacent to the first unwinder for determining a remaining amount of the first film wound around the first unwinder.

According to another exemplary embodiment of the present disclosure, the gripper of the automatic splicing equipment for the secondary battery according to the present disclosure may be configured to move in a straight line between an original position outside the first unwinder and the second unwinder and a cutting standby position crossing the vacuum adsorption unit.

According to another exemplary embodiment of the present disclosure, the gripper of the automatic splicing equipment for the secondary battery according to the present disclosure may include a pair of pressure units facing each other and movable toward or away from each other by a first driving means; and a pair of connectors, each having one end connected to the respective pressure unit and another end connected to the first driving means.

According to another exemplary embodiment of the present disclosure, the gripper of the automatic splicing equipment for the secondary battery according to the present disclosure may include a damage prevention unit placed inside the gripper for contacting the first film when moving to the cutting standby position due to a forward movement of the gripper.

According to another exemplary embodiment of the present disclosure, the first adsorption unit of the automatic splicing equipment for the secondary battery according to the present disclosure may include a 1-1 adsorption unit and a 1-2 adsorption unit spaced apart from each other along a forward and backward direction of the gripper, where the first adsorption unit moves in the direction adjacent to and away from the second adsorption unit.

According to another exemplary embodiment of the present disclosure, the second adsorption unit of the automatic splicing equipment for the secondary battery according to the present disclosure may include a 2-1 adsorption unit and a 2-2 adsorption unit spaced apart from each other along the forward and backward direction of the gripper, where the 2-1 adsorption unit and/or the 2-2 adsorption unit move forward and backward.

According to another exemplary embodiment of the present disclosure, the second adsorption unit of the automatic splicing equipment for the secondary battery according to the present disclosure may further include a pair of movement units configured to be connected to the 2-1 adsorption unit and the 2-2 adsorption unit, each having a rail groove formed therein; and a rail to be coupled to the rail groove of the pair of movement units.

According to another exemplary embodiment of the present disclosure, the tape supplier of the automatic splicing equipment for the secondary battery according to the present disclosure may include a plate-shaped mounting unit configured to mount a tape on the facing surfaces of the first film and the second film vacuum-adsorbed by the first adsorption unit and the second adsorption unit; and a picker connected to the mounting unit and including a handle configured for operator engagement.

According to another exemplary embodiment of the present disclosure, the damage prevention unit of the automatic splicing equipment for the secondary battery according to the present disclosure may include a pair of rollers.

According to another exemplary embodiment of the present disclosure, the pair of rollers of the automatic splicing equipment for the secondary battery according to the present disclosure may be placed along a vertical direction.

According to another exemplary embodiment of the present disclosure, an automatic splicing method for a secondary battery according to the present disclosure includes supplying a first film by rotating a first unwinder; moving a gripper fixed on one side of a second film in a straight line from an original position to a cutting standby position when it is determined that the first film wound around the first unwinder is exhausted; vacuum-adsorbing respectively the first film and the second film by a first adsorption unit and a second adsorption unit adjacent to each other; cutting the first film and the second film by moving a cutter; controlling the first adsorption unit and the second adsorption unit to move away from each other; and moving the gripper back from the cutting standby position to the original position, thereby recovering the first side of the second film.

According to another exemplary embodiment of the present disclosure, the automatic splicing method for the secondary battery according to the present disclosure further includes allowing a cut first side of the first film to be wound around the first unwinder by rotating the first unwinder; controlling the first adsorption unit and the second adsorption unit to be adjacent to each other; and allowing the first adsorption unit to vacuum-adsorb both a second side of the first film and a second side of the second film by releasing the vacuum of the second adsorption unit.

According to another exemplary embodiment of the present disclosure, the automatic splicing method for the secondary battery according to the present disclosure further includes controlling the second adsorption unit to move away from the first adsorption unit; controlling a 2-1 adsorption unit and a 2-2 adsorption unit to be spaced apart from each other; and allowing a tape on one side of the tape supplier to connect the second side of the first film to the second side of the second film by controlling one side of the tape supplier to be adjacent to the first adsorption unit.

According to another exemplary embodiment of the present disclosure, in the automatic splicing method for the secondary battery according to the present disclosure, the gripper may include a damage prevention unit disposed inside the gripper and configured to contact the first film during forward movement to the cutting standby position; and the method further comprises allowing the damage prevention unit to contact the first film when the gripper moves in a straight line from the original position to the cutting standby position.

The present disclosure may have the following effects by the present configuration described above. The present disclosure may have an effect of improving process efficiency by preventing the supply of a film from being interrupted while performing the process by connecting or joining a standby second film to a first film being supplied when the first film is exhausted while supplying the first film to the equipment for a back-end process.

In addition, the present disclosure may have an effect of automatically determining the remaining amount of a first film wound around a first unwinder by placing a detector on a side adjacent to the first unwinder.

In addition, the present disclosure may have an effect of facilitating structural simplification and accordingly design convenience by configuring to enable a gripper picking an end side of a second film to move only through a straight path rather than a rotation path.

In addition, the present disclosure may have an effect of facilitating easy accessibility by allowing a gripper to move to an original position accessible to an operator when supplying a second film to the gripper.

In addition, the present disclosure may have an effect of preventing lowering process efficiency due to no need to stop an operation of the equipment by allowing a gripper to move to an original position outside the equipment when supplying a second film to the gripper.

In addition, the present disclosure may have an effect of allowing a second film to be easily recovered to an outside of the equipment without separate recovery equipment by allowing a gripper fixed on one side of the second film to move from a cutting standby position to an original position after cutting the second film.

In addition, the present disclosure may have an effect of preventing damage to a first film being supplied in advance when a gripper moves from an original position to a cutting standby position, by forming a damage prevention unit inside the gripper.

In addition, the present disclosure may have an effect of preventing the possibility of safety accidents in advance by preventing an end side of a cutter from being exposed to an outside of a first adsorption unit under normal circumstances.

In addition, the present disclosure may have an effect of increasing the density of the equipment and preventing the entire equipment from becoming unnecessarily large by allowing a mounting unit, where a tape is mounted, to access a film through an isolated space between a pair of units of a second adsorption unit.

Meanwhile, even when an effect is not explicitly mentioned herein, the effects expected by the technical features of the present disclosure described in the following specification and the tentative effects thereof will be treated as ones described in the specification of the present disclosure.

### BRIEF DESCRIPTION OF THE DRAWINGS

FIG. 1 is a front view showing automatic splicing equipment for a secondary battery according to an exemplary embodiment of the present disclosure.

FIG. 2 is a illustrative view showing a gripper shown in FIG. 1.

FIG. 3 is a plan view showing a gripper shown in FIG. 2.

FIG. 4 is a illustrative view for illustrating a gripper moving to an original position and a cutting standby position shown in FIG. 2.

FIG. 5 is a illustrative view showing a vacuum adsorption unit shown in FIG. 1.

FIG. 6 is a illustrative view showing a first adsorption unit shown in FIG. 5.

FIG. 7 is a illustrative view showing a second adsorption unit shown in FIG. 5.

FIG. 8 is a illustrative view showing a tape supplier shown in FIG. 1.

FIGS. 9 to 17 are illustrative views for illustrating an automatic splicing method for a secondary battery according to an exemplary embodiment of the present disclosure.

### DETAILED DESCRIPTION OF THE DISCLOSURE

Hereinafter, exemplary embodiments of the present disclosure will be described in more detail with reference to the accompanying drawings. The exemplary embodiment of the present disclosure may be modified in various forms, and the scope of the present disclosure should not be construed as being limited to the following exemplary embodiments, but should be construed on the basis of the matters described in the claims. In addition, the present exemplary embodiment may be provided only for reference in order to more completely explain the present disclosure to a person having average knowledge in the art.

As used in the present specification, a singular form may include a plural form unless the context clearly dictates otherwise. In addition, when used in the present specification, “comprise” and/or “comprising” may specify the presence of the mentioned shapes, numbers, steps, operations, members, elements and/or groups thereof, and may not exclude the presence or addition of one or more other shapes, numbers, steps, operations, members, elements and/or groups thereof.

When explaining that a pair of components are “connected” to each other, it is understood as a concept to include not only both components being directly connected, but also being connected by a third component.

An exemplary embodiment of automatic splicing equipment 1 for a secondary battery will now be described in detail with reference to the accompanying drawings. The automatic splicing equipment 1 described herein may be applied to the splicing of a pouch film, an electrode, a separator, or similar materials. Although the following description is based on a separator(S) for convenience, it should be understood that the present disclosure is not limited thereto and may be equally applicable to other splicable components.

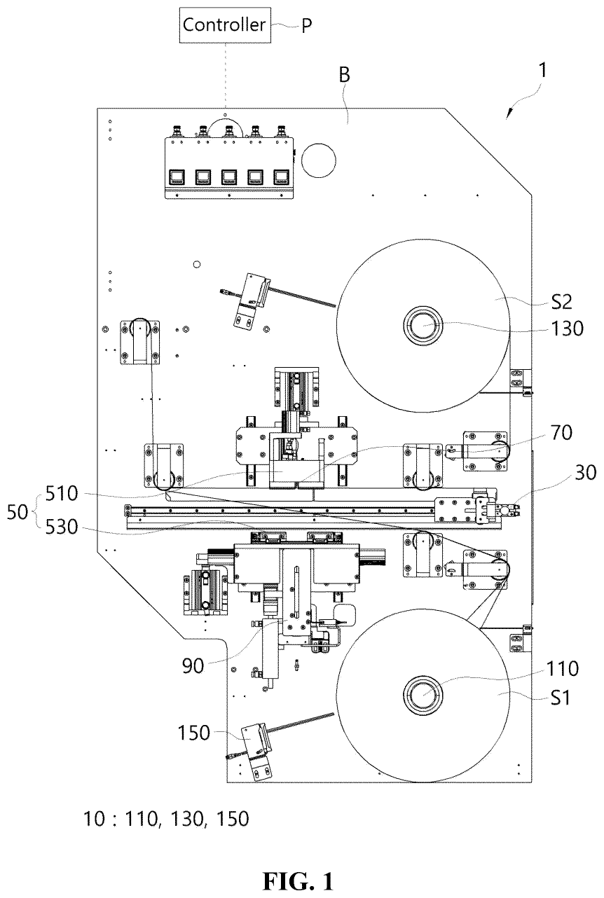

FIG. 1 is a front view showing automatic splicing equipment for a secondary battery according to an exemplary embodiment of the present disclosure.

Referring to FIG. 1, the present disclosure may relate to automatic splicing equipment 1 for a secondary battery and, more specifically, to automatic splicing equipment 1 for a secondary battery that improves process efficiency by preventing interruptions in separator supply, through automatic connection of a standby second separator (S2) to the separator (S1) being supplied when the separator (S1) is exhausted while supplying the first separator (S1) for a back-end process.

Hereinafter, the separator (S1) being already supplied will be referred to as “a first separator”, and the spare separator (S2), which is connected or joined to one side of the first separator (S1) and is supplied when the first separator is exhausted, will be referred to as “a second separator”.

The automatic splicing equipment 1 for the secondary battery according to an exemplary embodiment of the present disclosure may include an unwinder 10, a gripper 30, a vacuum adsorption unit 50, a cutter 70, and a tape supplier 90. In addition, the automatic splicing equipment 1 may further include a controller (P) for controlling the operation of the unwinder 10 to the tape supplier 90.

Referring to FIG. 1, the unwinder 10 may be configured to rotate in one direction under the control of the controller (P) while the separator(S) is wound in a roll so that the wound separator(S) can be supplied. To this end, the unwinder 10 may include a first unwinder 110 and a second unwinder 130.

The first unwinder 110 is configured to supply the first separator (S1), and the second unwinder 130 is configured to supply the second separator (S2), each by rotating in one direction. These first unwinder 110 and second unwinder 130 may be spaced apart from each other. In FIG. 1, the first unwinder 110 and the second unwinder 130 may be vertically spaced apart from each other, but may be spaced apart in a horizontal direction, and the present disclosure may not be limited thereto. In addition, in FIG. 1, the first unwinder 110 for supplying the first separator (S1) may be disposed at the lower side, and the second unwinder 130 for supplying the second separator (S2) may be disposed at the upper side, but in some cases, the unwinder disposed at the upper side may be the first unwinder 110 for supplying the first separator (S1). In addition, the first unwinder 110 and the second unwinder 130 may be fixed to be spaced apart from each other on the base (B) side, and the base (B) may be, for example, a roughly vertical plate-shaped configuration.

Also, a pair of detectors 150 for determining the remaining amount of the separator(S) wound on the individual unwinder (110, 130) may be formed on a side adjacent to the first unwinder 110 and the second unwinder 130. Such a detector 150 may be disposed each on a side adjacent to the first unwinder 110 and the second unwinder 130 and may determine the remaining amount of the wound first and second separator (S1, S2), for example, by measuring the distance to the outer surface/outer circumference of the adjacent unwinders 110, 130. As another example, the remaining amount of the separator(S) may be determined on the basis of the number of revolutions of the individual unwinders 110, 130, and the present disclosure may not be limited thereto. When it is determined that the first separator (S1) on the side of the rotating first unwinder 110 is exhausted by the detector 150, the controller (P) may control a forward operation of the gripper 30 to be described later. The detector 150 may also be formed on the base (B).

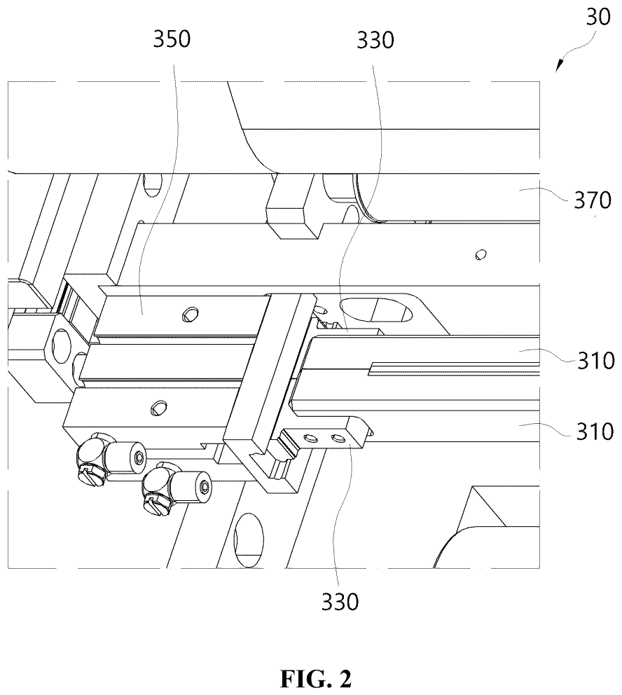

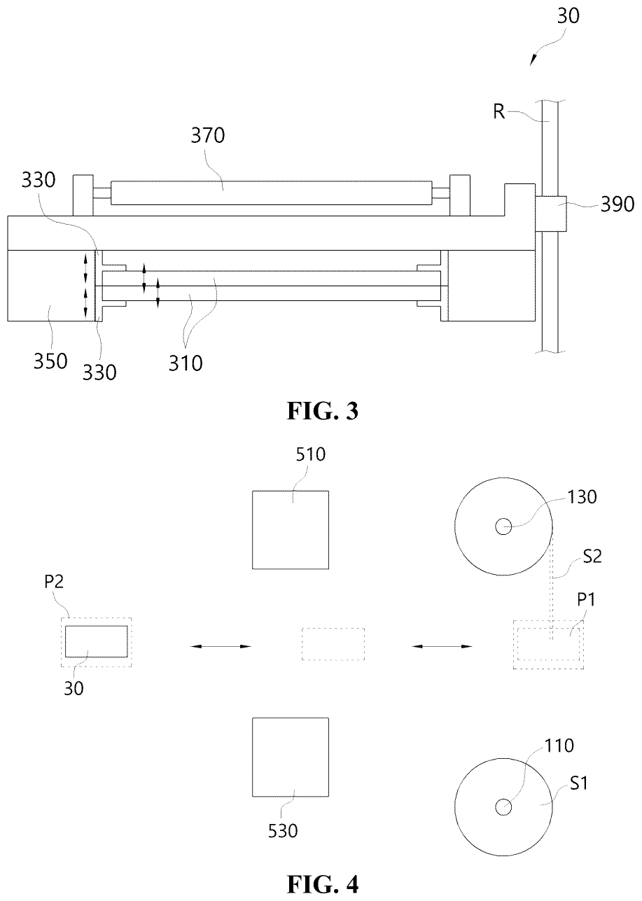

FIG. 2 is a illustrative view showing a gripper shown in FIG. 1, FIG. 3 is a plan view showing a gripper shown in FIG. 2, and FIG. 4 is a illustrative view for illustrating a gripper moving to an original position and a cutting standby position shown in FIG. 2.

Referring to FIGS. 1 to 4, the gripper 30 may be configured to move in a straight line in a state of picking an end side of the second separator (S2), for example, one side of the second separator (S2). For example, the gripper 30 may be configured to move in a straight line between the original position (P1) and the cutting standby position (P2). In this case, the original position (P1) may be the outside of the first unwinder 110 and the second unwinder 130 opposite to the vacuum adsorption unit 50, and the cutting standby position (P2) may be the side crossing the vacuum adsorption unit 50. The direction from the original position (P1) to the cutting standby position (P2) may be consistent with the supply direction of the separator(S) from the unwinder 10.

In more detail, it is preferable that the gripper 30 moves in a straight line between the original position (P1) and the cutting standby position (P2) between the first unwinder 110 and the second unwinder 130. Hereinafter, it is understood that the “forward movement” of the gripper 30 describes the movement of the gripper 30 in the direction crossing the first unwinder 110 and the second unwinder 130 and the vacuum adsorption unit 50, and the “backward movement” describes the movement in the direction opposite to the forward movement. The straight movement of the gripper 30 may be performed by a driving means such as a motor connected to the gripper 30, and there are no separate limitations thereon.

Accordingly, when the gripper 30 is placed at the original position (P1), the operator may easily access the gripper 30 and may supply the second separator (S2) to the gripper 30. In this way, there is no need to stop the equipment 1 when supplying the second separator (S2) to the equipment 1 by allowing the second separator (S2) to be supplied while the gripper 30 moves to the original position (P1) accessible to the operator, thereby improving process efficiency. In addition, since the gripper 30 moves from the cutting standby position (P2) to the original position (P1) after performing the cutting process of the second separator (S2) by the cutter 70 to be described later, the cut end side of the second separator (S2) may be automatically recovered to the outside of the automatic splicing equipment 1 without separate recovery equipment. Also, as shown above, the gripper 30 may perform only a straight reciprocating movement from the original position (P1) to the cutting standby position (P2) without a separate rotational movement so that structural simplification and design convenience can be guaranteed.

The gripper 30 as described above may include a pressure unit 310, a connecter 330, a first driving means 350, a damage prevention unit 370, and a coupler 390.

The pressure unit 310 may be configured to be a pair facing each other and moving in a direction adjacent to or away from each other by the first driving means 350, and may be formed in a plate shape as an example, but the scope of the present disclosure may not be limited thereto. In this case, it is preferable that the sides facing each other of the pair of pressure units 310 are formed substantially flat. Explaining the operation of the pressure unit 310, when the operator inputs one side of the second separator (S2) between the pair of pressure units 310, the pair of pressure units 310 may move in a direction adjacent to each other by driving the first driving means 350 and may be in contact with both sides of the input second separator (S2) so that the second separator (S2) can be fixed.

The connector 330 may be configured to be a pair where one side is connected to the individual pressure unit 310 and the other side is connected to the first driving means 350, and the connected pressure unit 310 may move in a straight line when driving the first driving means 350. The other side of the connector 330 may be formed in, for example, a rail shape and can be coupled to the rail groove 351 of the first driving means 350, but the scope of the present disclosure is not limited thereto.

The first driving means 350 may be connected to the pair of connectors 330 so that the connectors 330 can move in a straight line and may include, for example, a hydraulic cylinder, a pneumatic cylinder, or a motor, but the scope of the present disclosure may not be limited by the example.

The damage prevention unit 370 may be formed on the inside of the gripper 30 and may be a roller for preventing damage caused by interference with the first separator (S1) being supplied when moving to the cutting standby position (P2) by the forward movement of the gripper 30. That is, the damage prevention unit 370 may prevent damage to the first separator (S1) when the first separator (S1) already supplied along the supply route is in contact the gripper 30 by the forward movement of the gripper 30. Such a damage prevention unit 370 may be spaced apart from each other to be formed as a pair. In addition, it is understood that the “inside of the gripper 30” refers to the side adjacent to the vacuum adsorption unit 50 when the gripper 30 is placed in the original position (P1).

The coupler 390 may be formed at an end side of the gripper 30 and may be configured to allow the gripper 30 to move forward and backward by being coupled to the base (B). For example, the coupler 390 in the shape of a rail groove may be formed at an end side of the gripper 30, and the coupler 390 may be coupled to the rail (R) formed on the outer surface of the base (B). The coupler 390 may move in a straight line between the original position (P1) and the cutting standby position (P2) by a driving means formed as, for example, a motor or the like.

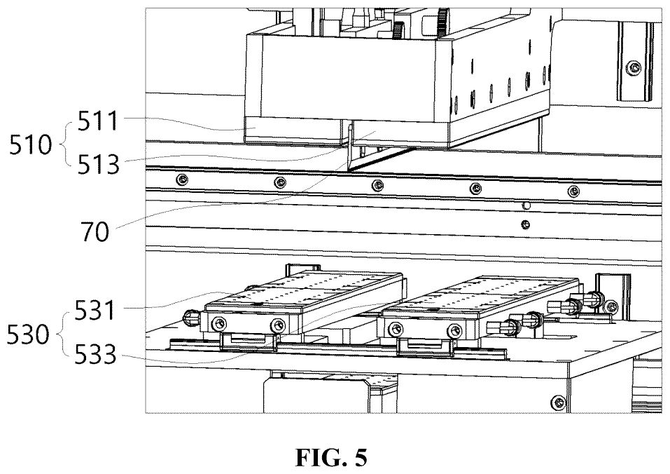

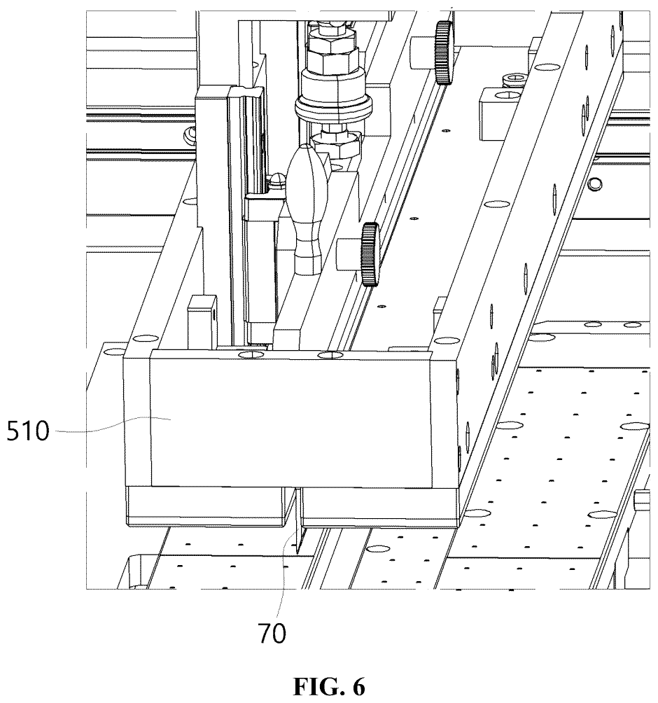

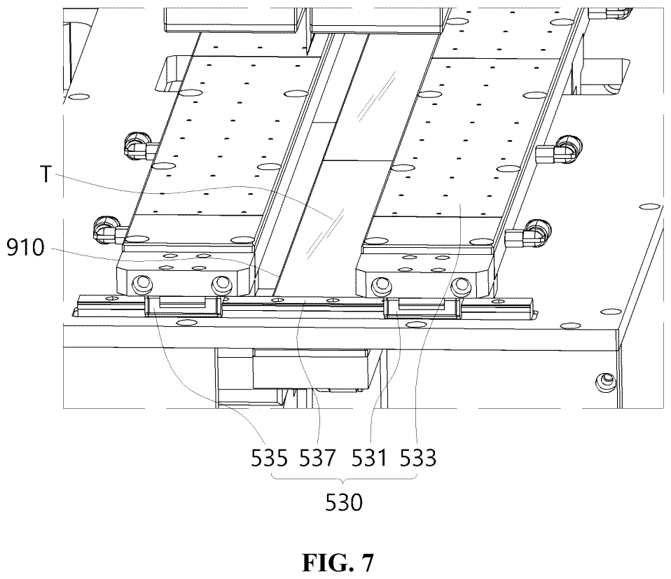

FIG. 5 is a illustrative view showing a vacuum adsorption unit shown in FIG. 1, FIG. 6 is a illustrative view showing a first adsorption unit shown in FIG. 5, and FIG. 7 is a illustrative view showing a second adsorption unit shown in FIG. 5.

Referring to FIGS. 1 and 5 to 7, the vacuum adsorption unit 50 may be configured to be a pair of plate-shaped structures being spaced apart from each other and vacuum-adsorbing the facing surfaces of the first separator (S1) and the second separator (S2), respectively. The pair of vacuum adsorption units 50 may be controlled to be adjacent to or away from each other in a state of being spaced apart from each other in the direction same as the separation direction of the first unwinder 110 and the second unwinder 130. In this case, only one component of the pair of vacuum adsorption units 50 may be controlled to be movable, or both components may be controlled to be movable, and there are no separate limitations.

In addition, the individual vacuum adsorption unit 50 may be formed into two units, respectively, along the forward and backward direction of the gripper 30. Also, a plurality of adsorption holes may be formed on the surface of the individual vacuum adsorption unit 50 facing the separator(S). To this end, the vacuum adsorption unit 50 may include a first adsorption unit 510 and a second adsorption unit 530.

The first adsorption unit 510 may be configured to be formed into two units (hereinafter, referred to as a “1-1 adsorption unit 511” and a “1-2 adsorption unit 513”), respectively, along the forward and backward direction of the gripper 30, and to vacuum-adsorb the facing surface of the separator (S, the first separator or the second separator). In addition, the 1-1 adsorption unit 511 and the 1-2 adsorption unit 513 may be spaced apart from each other and, through the isolated space, the end side of the cutter 70 to be described later may approach the vacuum-adsorbed separator(S), thereby cutting the first separator (S1) and the second separator (S2). Also, the first adsorption unit 510 may be configured to move toward a side adjacent to or away from the second adsorption unit 530.

The second adsorption unit 530 may be configured to be formed into two units (hereinafter, referred to as a “2-1 adsorption unit 531” and a “2-2 adsorption unit 533”) along the forward and backward direction of the gripper 30, and to vacuum-adsorb the facing surface of the separator (S, the first separator or the second separator). In this case, the 2-1 adsorption unit 531 and/or the 2-2 adsorption unit 533 may be configured to move forward and backward. For example, one side of the 2-1 adsorption unit 531 and/or the 2-2 adsorption unit 533 may be connected to a movement unit 535 where the rail groove is formed, and the movement unit 535 may be coupled to the rail 537. When the 2-1 adsorption unit 531 and the 2-2 adsorption unit 533 are spaced apart from each other, the tape supplier 90 may approach the separator(S) through the isolated space, and may connect the end sides of the first separator (S1) and the second separator (S2) to each other, and a detailed description thereof will be described later. Also, the second adsorption unit 530 may be configured to move toward a side adjacent to or away from the first adsorption unit 510.

Referring to FIGS. 5 and 6, the cutter 70 may be disposed at an isolated space between the pair of units of the first adsorption part 510 and may be configured to move toward the separator(S) between the first adsorption unit 510 and the second adsorption unit 530 or toward the opposite direction. For example, the cutter 70 may be configured to move by a driving means such as a hydraulic cylinder or a pneumatic cylinder, but the scope of the present disclosure may not be limited by the above example. In addition, it is preferable to prevent the possibility of a safety accident by preventing the end side of the cutter 70 from being exposed to the outside of the first adsorption unit 510 when the cutting operation of the separator(S) is not performed.

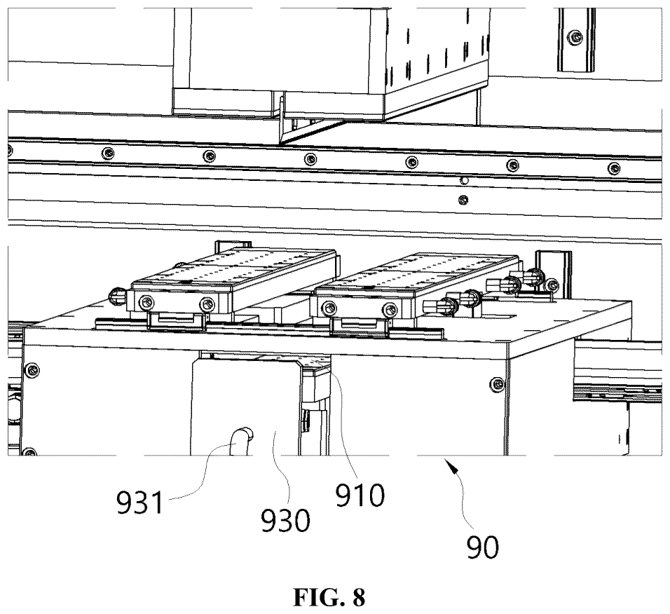

FIG. 8 is a illustrative view showing a tape supplier shown in FIG. 1.

Referring to FIGS. 1 and 8, the tape supplier 90 may be disposed on the side adjacent to the second adsorption unit 530 and may be configured to move toward the separator(S) between the first adsorption unit 510 and the second adsorption unit 530 or toward the opposite direction. On one side of the tape supplier 90, a tape (T) may be placed for connecting or joining the end sides of the first separator (S1) and the second separator (S2). To this end, the tape supplier 90 may include a mounting unit 910 and a picker 930.

The mounting unit 910 may be configured to be in a plate shape to allow the tape (T) to be mounted on the surface facing the separator(S) vacuum-adsorbed by the first adsorption unit 510 and the second adsorption unit 530. The mounting unit 910 may be configured to move toward the direction adjacent to or away from the separator(S) by driving the driving means. The driving means may be, for example, a hydraulic cylinder or a pneumatic cylinder, but the scope of the present disclosure may not be limited thereto. In addition, it is preferable that the tape mounting surface of the mounting unit 910 is formed into a substantially flat shape.

The picker 930 may be configured to be connected to the mounting unit 910 and to be formed with a handle for the operator to pick. For example, when the operator pulls in a state of holding the handle, the mounting unit 910 may be exposed to the outside of the equipment 1 and, in this state, the operator may supply the tape (T) to the mounting unit 910. After supplying the tape (T) to the mounting unit 910, the mounting unit 910 may be placed in the original position when the operator pushes in a state of holding the handle 931.

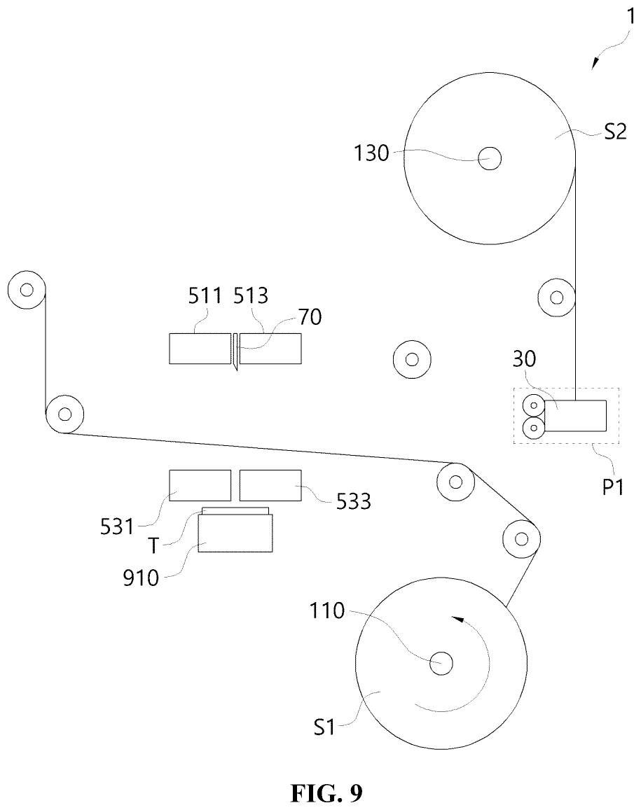

FIGS. 9 to 17 are illustrative views for illustrating an automatic splicing method for a secondary battery according to an exemplary embodiment of the present disclosure.

Hereinafter, an automatic splicing method for a secondary battery according to an exemplary embodiment of the present disclosure will be described in detail with reference to the accompanying drawings.

Referring to FIG. 9, the first unwinder 110 may be first controlled to rotate through the controller (P) so that the first separator (S1) is supplied. In this case, the gripper 30 may be at the original position (P1), and the operator may insert into and fix in the gripper 30 the second separator (S2) wound around the second unwinder 130. In addition, the operator may pull the handle of the picker 930 to supply the tape (T) to the mounting unit 910 and then may push the handle to place the mounting unit 910 on the lower side of the second adsorption unit 530.

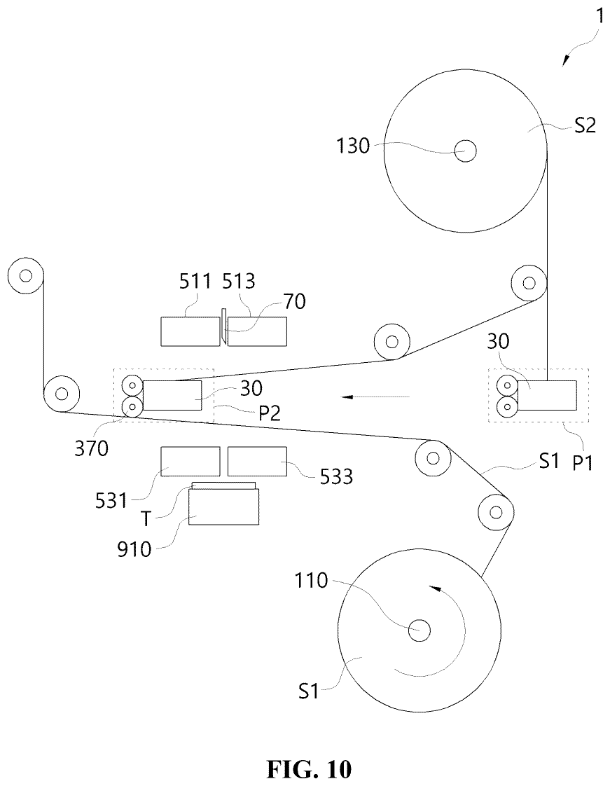

Also, referring to FIG. 10, the detector 150 may transmit information about the remaining amount of the first separator (S1) wound around the first unwinder 110 to the controller (P) and the controller (P) may control the gripper 30 to move from the original position (P1) to the cutting standby position (P2) when it is determined that the first separator (S1) wound around the first unwinder 110 is almost exhausted.

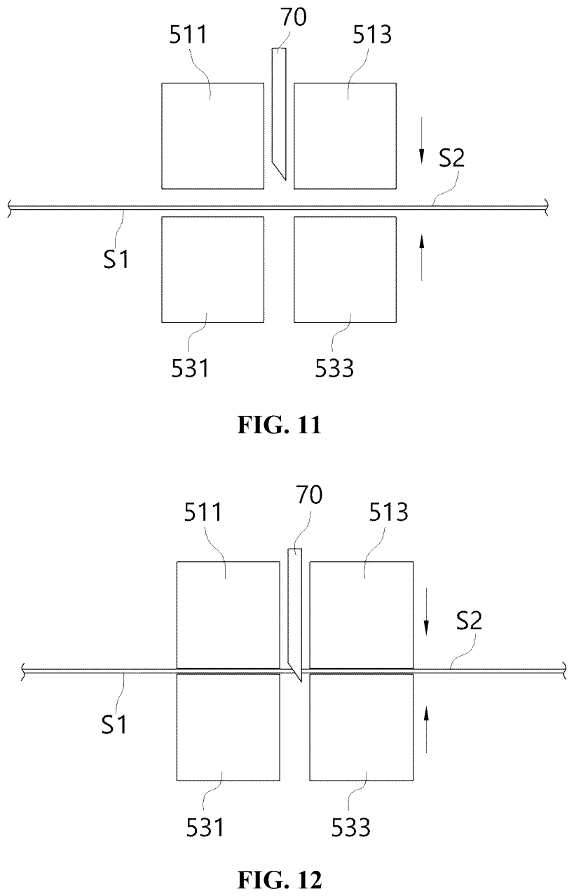

Then, referring to FIG. 11, the controller (P) may control the operation of the first adsorption unit 510 and the second adsorption unit 530 so that the first adsorption unit 510 and the second adsorption unit 530 vacuum-adsorb a pair of separators(S). For convenience of description, it is exemplarily explained that the first adsorption unit 510 vacuum-adsorbs the second separator (S2) and the second adsorption unit 530 vacuum-adsorbs the first separator (S1). For vacuum adsorption of the separator(S) by the individual adsorption units 510, 530, the adsorption units 510, 530 may be controlled to move in a direction adjacent to the separator(S). In the illustrated drawing, the first adsorption unit 510 may be controlled to descend, and the second adsorption unit 530 may be controlled to ascend. Thereafter, referring to FIG. 12, the end side of the cutter 70 may move toward the separator(S) under the control of the controller (P), thereby cutting the first separator (S1) and the second separator (S2).

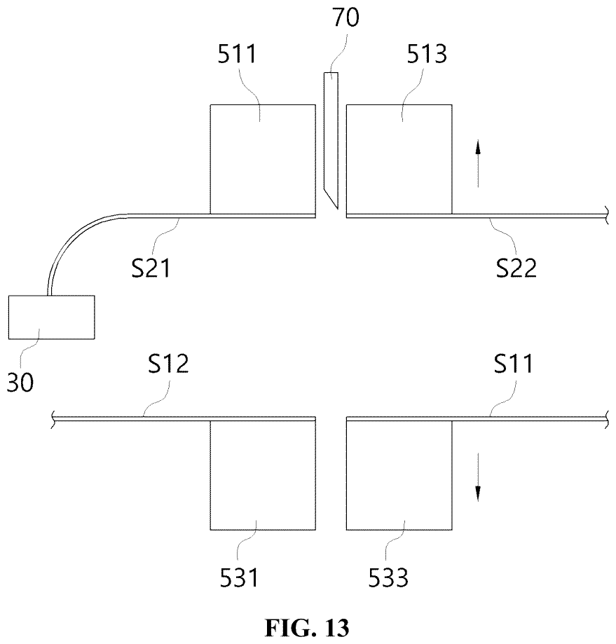

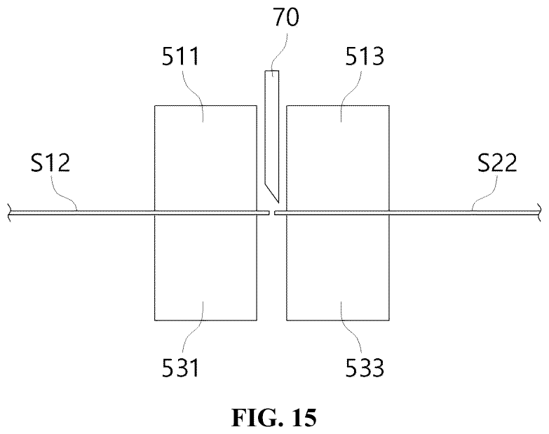

Referring to FIG. 13, when finishing the cutting of the first separator (S1) and the second separator (S2), the controller (P) may control the first adsorption unit 510 and/or the second adsorption unit 530 to be spaced apart from each other. For example, the first adsorption unit 510 may be controlled to ascend and the second adsorption unit 530 may be controlled to descend. In this case, the first adsorption unit 510 may still be in a state of vacuum-adsorbing the cut second separator (S2), and the second adsorption unit 530 may still be in a state of vacuum-adsorbing the cut first separator (S1). In FIGS. 13 to 15, the cut end side of the separator is depicted as being aligned with the end side of the corresponding vacuum adsorption unit, but it is common that the cut end side of the individual separator protrudes outward from the corresponding vacuum adsorption unit as shown in FIG. 15.

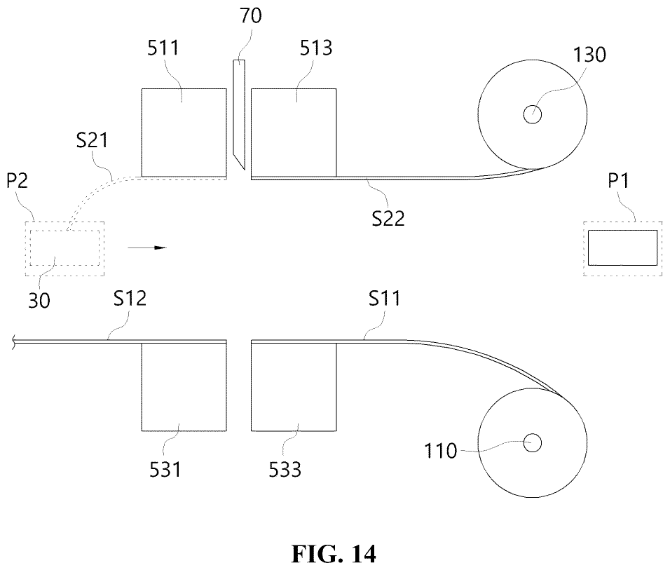

Thereafter, referring to FIG. 14, the gripper 30 may move from the cutting standby position (P2) to the original position (P1) under the control of the controller (P). In this case, the gripper 30 may move to the original position (P1) in a state of gripping the cut portion (S21) of the second separator (S2). Accordingly, the portion (S21) of the second separator (S2) may be easily recovered to the outside of the equipment 1. In addition, the first unwinder 110 may be rotated in the opposite direction under the control of the controller (P) so that the cut portion (S11) of the first separator (S1) can be wound around the first unwinder 110. In this case, the remaining portion (S22) of the second separator (S2) may be in a state of being vacuum-adsorbed to the 1-2 adsorption unit 513, and the remaining portion (S12) of the first separator (S1) may be in a state of being vacuum-adsorbed to the 2-1 adsorption unit 531.

Thereafter, referring to FIG. 15, the controller (P) may control the first adsorption unit 510 and/or the second adsorption unit 530 so that the first adsorption unit 510 and the second adsorption unit 530 move to the position adjacent to each other. For example, the first adsorption unit 510 may descend and the second adsorption unit 530 may ascend. Also, the controller (P) may break the vacuum of the second adsorption unit 530, such that the portion (S12) of the first separator (S1) and the portion (S22) of the second separator (S2) may be both vacuum-adsorbed to the first adsorption unit 510.

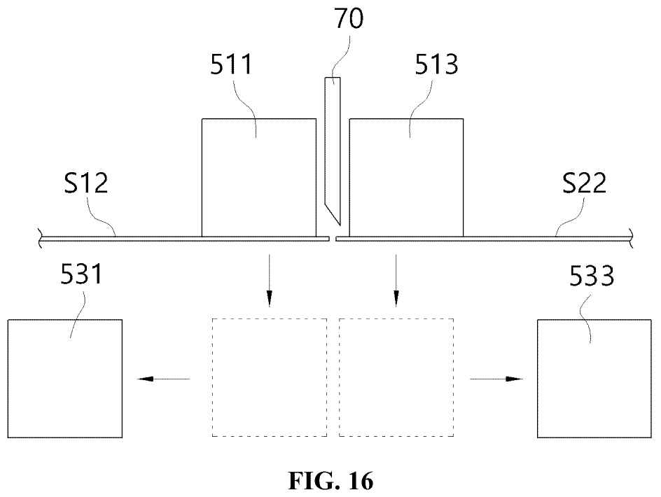

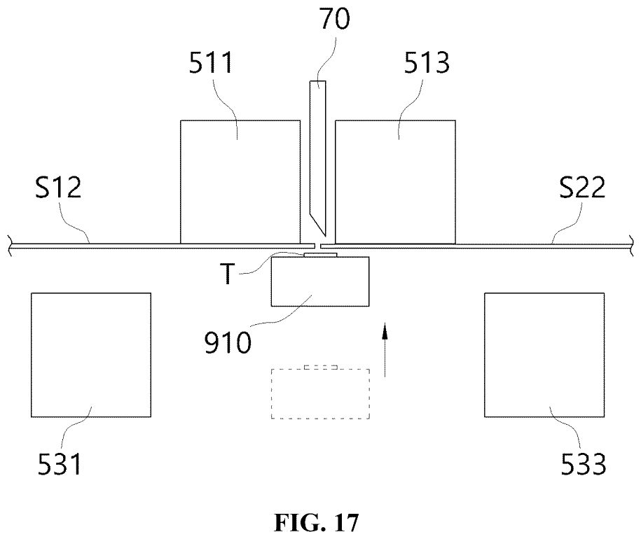

Then, referring to FIG. 16, the controller (P) may control the second adsorption unit 530 to descend and the 2-1 adsorption unit 531 and the 2-2 adsorption unit 533 to be spaced apart from each other, and referring to FIG. 17, the mounting unit 910 of the tape supplier 90 may be controlled to be adjacent to the first adsorption unit 510 through the isolated space. This may enable the adhesive surface of the tape (T) to be attached to the boundary of the portion (S12) of the first separator (S1) and the portion (S22) of the second separator (S2) which are vacuum-adsorbed to the first adsorption unit 510.

The foregoing detailed description may be illustrative of the present disclosure. In addition, the foregoing description may be intended to illustrate preferred exemplary embodiments of the present disclosure, and the present disclosure may be used in various other combinations, changes, and environments. That is, changes or modifications are possible within the scope of the inventive concept disclosed in this specification, the scope equivalent to the disclosed content, and/or the scope of technology or knowledge in the art. The foregoing exemplary embodiments may describe the best state for implementing the technical ideas of the present disclosure, and various changes required in the specific application field and usage of the present disclosure may be also possible. Therefore, the foregoing detailed description of the present disclosure may not be intended to limit the present disclosure to the disclosed exemplary embodiment.

What is claimed is:

1. Automatic splicing equipment for a secondary battery, the equipment comprising:
an unwinder comprising a first unwinder for supplying a first film by rotating in one direction while the first film is wound in a roll; and a second unwinder for supplying a second film by rotating in one direction while the second film is wound in a roll;
a gripper for moving in a straight line while one side of the second film is fixed;
a vacuum adsorption unit comprising a first adsorption unit and a second adsorption unit that are spaced apart from each other and configured to respectively vacuum-adsorb the facing surfaces of the first film and the second film;
a cutter disposed in an isolated space between a pair of units of the first adsorption unit, the cutter being configured to move an end portion in a straight line toward or away from the second adsorption unit;
a tape supplier disposed adjacent to the second adsorption unit and configured to move linearly toward or away from the first adsorption unit; and
a controller configured to control operations of the automatic splicing equipment for the secondary battery.

2. The equipment of claim 1, wherein the unwinder comprises
a detector disposed adjacent to the first unwinder for determining a remaining amount of the first film wound around the first unwinder.

3. The equipment of claim 1, wherein the gripper
moves in a straight line between an original position outside the first unwinder and the second unwinder and a cutting standby position crossing the vacuum adsorption unit.

4. The equipment of claim 3, wherein the gripper comprises:
a pair of pressure units facing each other and movable toward or away from each other by a first driving means; and
a pair of connectors, each having one end connected to the respective pressure unit and another end connected to the first driving means.

5. The equipment of claim 3, wherein the gripper further comprises
a damage prevention unit placed inside the gripper for contacting the first film when moving to the cutting standby position due to a forward movement of the gripper.

6. The equipment of claim 3, wherein the first adsorption unit comprises
a 1-1 adsorption unit and a 1-2 adsorption unit spaced apart from each other along a forward and backward direction of the gripper,
where the first adsorption unit moves in the direction adjacent to and away from the second adsorption unit.

7. The equipment of claim 6, wherein the second adsorption unit comprises
a 2-1 adsorption unit and a 2-2 adsorption unit spaced apart from each other along the forward and backward direction of the gripper,
where the 2-1 adsorption unit and/or the 2-2 adsorption unit move forward and backward.

8. The equipment of claim 7, wherein the second adsorption unit further comprises:
a pair of movement units configured to be connected to the 2-1 adsorption unit and the 2-2 adsorption unit, each having a rail groove formed therein; and
a rail to be coupled to the rail groove of the pair of movement units.

9. The equipment of claim 7, wherein the tape supplier comprises:
a plate-shaped mounting unit configured to mount a tape on the facing surfaces of the first film and the second film vacuum-adsorbed by the first adsorption unit and the second adsorption unit; and
a picker connected to the mounting unit and including a handle configured for operator engagement.

10. The equipment of claim 5, wherein the damage prevention unit comprises
a pair of rollers.

11. The equipment of claim 10, wherein the pair of rollers
is placed along a vertical direction.

12. An automatic splicing method for a secondary battery, the method comprising:
supplying a first film by rotating a first unwinder;
moving a gripper fixed on one side of a second film in a straight line from an original position to a cutting standby position when it is determined that the first film wound around the first unwinder is exhausted;
vacuum-adsorbing respectively the first film and the second film by a first adsorption unit and a second adsorption unit adjacent to each other;
cutting the first film and the second film by moving a cutter;
controlling the first adsorption unit and the second adsorption unit to move away from each other; and
moving the gripper back from the cutting standby position to the original position, thereby recovering the first side of the second film.

13. The method of claim 12, further comprising:
allowing a cut first side of the first film to be wound around the first unwinder by rotating the first unwinder;
controlling the first adsorption unit and the second adsorption unit to be adjacent to each other; and
allowing the first adsorption unit to vacuum-adsorb both a second side of the first film and a second side of the second film by releasing the vacuum of the second adsorption unit.

14. The method of claim 13, further comprising:
controlling the second adsorption unit to move away from the first adsorption unit;
controlling a 2-1 adsorption unit and a 2-2 adsorption unit to be spaced apart from each other; and
allowing a tape on one side of the tape supplier to connect the second side of the first film to the second side of the second film by controlling one side of the tape supplier to be adjacent to the first adsorption unit.

15. The method of claim 12, wherein the gripper comprises
a damage prevention unit disposed inside the gripper and configured to contact the first film during forward movement to the cutting standby position; and
the method further comprises allowing the damage prevention unit to contact the first film when the gripper moves in a straight line from the original position to the cutting standby position.
